(19) United States
(12) Patent Application Publication
(10) Pub. No.: US 2025/0337900 A1
(43) Pub. Date: Oct. 30, 2025

(54) NON-UNIFORM CLASSIFICATION FOR ADAPTIVE LOOP FILTER CLASSIFIER

(71) Applicant: Tencent America LLC, Palo Alto, CA (US)

(72) Inventors: Roman CHERNYAK, Santa Clara, CA (US); Lien-fei CHEN, Palo Alto, CA (US); Xin ZHAO, San Jose, CA (US); Xiaozhong XU, State College, PA (US); Biao WANG, San Jose, CA (US); Madhu PERINGASSERY KRISHNAN, Mountain View, CA (US); Shan LIU, San Jose, CA (US)

(73) Assignee: Tencent America LLC, Palo Alto, CA (US)

(21) Appl. No.: 19/261,994

(22) Filed: Jul. 7, 2025

Related U.S. Application Data
(63) Continuation of application No. PCT/US2024/025604, filed on Apr. 20, 2024.
(60) Provisional application No. 63/461,225, filed on Apr. 21, 2023.

(51) Int. Cl. H04N 19/117; H04N 19/176; H04N 19/82

(52) U.S. Cl. CPC H04N 19/117; H04N 19/176; H04N 19/82

(57) ABSTRACT

An apparatus includes processing circuitry configured to receive coded information of one or more pictures, the coded information is indicative of a use of a non-uniform classification for applying a filter. The processing circuitry calculates a classification value associated with a classification unit for applying the filter on the classification unit, the classification unit is in a current block. Also, the processing circuitry determines a filtering class from a plurality of filtering classes for the classification unit based on the classification value in a dynamic range, the plurality of filtering classes is distributed in the dynamic range according to a non-uniform distribution. Further, the processing circuitry is configured to obtain filter coefficients associated with the filtering class, generate at least a filtered sample of classification unit according to the filter coefficients, and reconstruct the current block based on at least the filtered sample.

### RELATED APPLICATIONS

The present application is a continuation of International Application No. PCT/US2024/025604, entitled “NON-UNIFORM CLASSIFICATION FOR ADAPTIVE LOOP FILTER CLASSIFIER” and filed on Apr. 20, 2024, which claims the benefit of priority to U.S. Provisional Application No. 63/461,225, “NON-UNIFORM CLASSIFICATION FOR ADAPTIVE LOOP FILTER CLASSIFIER” filed on Apr. 21, 2023. The entire disclosures of the prior applications are hereby incorporated by reference.

### TECHNICAL FIELD

The present disclosure describes embodiments generally related to video coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Image/video compression can help transmit image/video data across different devices, storage and networks with minimal quality degradation. In some examples, video codec technology can compress video based on spatial and temporal redundancy. In an example, a video codec can use techniques referred to as intra prediction that can compress an image based on spatial redundancy. For example, the intra prediction can use reference data from the current picture under reconstruction for sample prediction. In another example, a video codec can use techniques referred to as inter prediction that can compress an image based on temporal redundancy. For example, the inter prediction can predict samples in a current picture from a previously reconstructed picture with motion compensation. The motion compensation can be indicated by a motion vector (MV).

### SUMMARY

Aspects of the disclosure include methods and apparatuses for video encoding/decoding.

Some aspects of the disclosure provide a method of processing visual media data. The method includes processing a bitstream of visual media data according to a format rule. The bitstream includes coded information of one or more pictures. The format rule specifics that a use of a non-uniform classification for an adaptive loop filter (ALF) is determined for applying onto a current block in a current picture, and a classification value associated with a classification unit for applying the ALF is calculated, the classification unit is in the current block. The format rule further specifies that a filtering class is determined from a plurality of filtering classes for the classification unit based on the classification value in a dynamic range, the plurality of filtering classes is distributed in the dynamic range according to a non-uniform distribution, the dynamic range includes at least a first filtering class corresponding to a first range of values in the dynamic range and a second filtering class corresponding to a second range of values in the dynamic range, the first range of values has a difference range size from the second range of values. The format rule further specifies that filter coefficients associated with the filtering class are determined, and at least a filtered sample of classification unit is generated according to the filter coefficients of the ALF.

Some aspects of the disclosure provide an apparatus for video decoding, the apparatus includes processing circuitry configured to receive coded information of one or more pictures, the coded information is indicative of a use of a non-uniform classification for applying a filter. The processing circuitry is configured to calculate a classification value associated with a classification unit for applying the filter on the classification unit, the classification unit is in a current block in a current picture. Also, the processing circuitry is configured to determine a filtering class from a plurality of filtering classes for the classification unit based on the classification value in a dynamic range, the plurality of filtering classes is distributed in the dynamic range according to a non-uniform distribution. Further, the processing circuitry is configured to obtain filter coefficients associated with the filtering class that is determined for the classification unit, generate at least a filtered sample of classification unit according to the filter coefficients, and reconstruct the current block based on at least the filtered sample.

In some examples, the dynamic range includes at least a first filtering class corresponding to a first range of values in the dynamic range and a second filtering class corresponding to a second range of values in the dynamic range, the first range of values has a difference range size from the second range of values.

In some examples, the dynamic range includes sub-intervals with indices ranging from 0 to k-1, k is a sub-interval number, range sizes of the sub-intervals are set to [r₀, r₁, . . . , rₖ₋₁] respectively, the sub-intervals have corresponding class numbers [num₀, num₁, . . . , numₖ₋₁], and a sum of the corresponding class numbers for the sub-intervals is equal to a total class number numₜₒₜₐₗ of the plurality of filtering classes. The processing circuitry is configured to determine the filtering class based on a specific sub-interval that the classification value belongs to and a specific class number in the specific sub-interval.

In some examples, the dynamic range is non-uniformly divided into the sub-intervals, each sub-interval is associated with one filtering class in the plurality of filtering classes, and the processing circuitry is configured to determine the filtering class based on the specific sub-interval the classification value belongs.

In some examples, the dynamic range includes the sub-intervals with non-uniform interval sizes r₀, r₁, . . . , rₖ₋₁, and

$$\frac{{r}_{0}}{{num}_{0}} , \frac{{r}_{1}}{{num}_{1}} , ... , \frac{{r}_{k - 1}}{{num}_{k - 1}}$$

are not of a same value. In an example, num₀, num₁, . . . , numₖ₋₁ are of a same value.

In some examples, the dynamic range includes at least a first sub-interval and a second sub-interval of different interval ranges, the first sub-interval and the second sub-interval has a same class number.

In some examples, the dynamic range includes at least a first sub-interval and a second sub-interval of a same interval size, the first sub-interval has a first class number, the second sub-interval has a second class number, and the first class number is different from the second class number.

In some examples, the dynamic range includes the sub-intervals of a same interval size, the corresponding class numbers num₀, num₁, . . . , numₖ₋₁ of the sub-intervals are not of a same number.

In some examples, the processing circuitry is configured to determine a specific sub-interval that the classification value belongs to, and determine a specific class in the specific sub-interval for the classification value.

In some examples, the processing circuitry is configured to decode, from one or more high level syntax elements in the coded information, one or more signals for the non-uniform distribution, the one or more high level syntax elements are in at least one of a video parameter set (VPS), a sequence parameter set (SPS), a picture parameter set (PPS), an adaptation parameter set (APS), a picture header, and a slice header.

In an example, the sub-interval number, range sizes of the sub-intervals, and class numbers in the sub-intervals are predefined parameters for the non-uniform distribution, and the processing circuitry is configured to decode, from the coded information, a flag that indicates whether the non-uniform distribution is used.

In another example, the processing circuitry is configured to decode, from the coded information, a flag that indicates whether the non-uniform distribution is used, and decode, when the flag indicates that the non-uniform distribution is used, at least one the sub-interval number, range sizes of the sub-intervals, and class numbers in the sub-intervals from the coded information.

In some examples, the filter is an adaptive loop filter.

In some examples, the classification value is one of a sample value, a residual value, and a derived value from a window that covers the classification unit.

Some aspects of the disclosure provide a method for video encoding. The method includes determining a use of a non-uniform classification for an adaptive loop filter (ALF) to apply to a current block in a current picture, and calculating a classification value associated with a classification unit for applying the ALF, the classification unit is associated with the current block. The method further includes determining a filtering class from a plurality of filtering classes for the classification unit based on the classification value in a dynamic range, the plurality of filtering classes is distributed in the dynamic range according to a non-uniform distribution, the dynamic range includes at least a first filtering class corresponding to a first range of values in the dynamic range and a second filtering class corresponding to a second range of values in the dynamic range, the first range of values has a difference range size from the second range of values. The method further includes obtaining filter coefficients associated with the filtering class that is determined for the classification unit; and generating at least a filtered sample of classification unit according to the filter coefficients of the ALF.

In some examples, the dynamic range includes sub-intervals with indices ranging from 0 to k-1, k is a sub-interval number for the sub-intervals, range sizes of the sub-intervals are set to [r₀, r₁, . . . , rₖ₋₁] respectively, the sub-intervals have corresponding class numbers [num₀, num₁, . . . , numₖ₋₁], and a sum of the corresponding class numbers for the sub-intervals is equal to a total class number numₜₒₜₐₗ of the plurality of filtering classes. The method comprises determining the filtering class based on a specific sub-interval that the classification value belongs to and a specific class number in the specific sub-interval.

In some examples, the dynamic range includes the sub-intervals with respective non-uniform interval sizes r₀, r₁, . . . , rₖ₋₁, and num₀, num₁, . . . , numₖ₋₁ are of a same value. In an example, the dynamic range includes the sub-intervals of a same interval size, the corresponding class numbers num₀, num₁, . . . , numₖ₋₁ of the sub-intervals are not of a same number.

According to another aspect of the disclosure, an apparatus is provided. The apparatus includes processing circuitry. The processing circuitry can be configured to perform any of the described methods for video decoding/encoding.

Aspects of the disclosure also provide a non-transitory computer-readable medium storing instructions which, when executed by a computer, cause the computer to perform any of the described methods for video decoding/encoding.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an exemplary block diagram of a communication system (100).

FIG. 2 is a schematic illustration of an exemplary block diagram of a decoder.

FIG. 3 is a schematic illustration of an exemplary block diagram of an encoder.

FIG. 4 shows a diagram of filtering according to an embodiment of the disclosure.

FIG. 5 shows a diagram of two filter shapes in some examples.

FIGS. 6A-6D show examples of subsampled positions used for calculating gradients in some examples.

FIG. 7 shows an example of filter shapes using residual samples as additional inputs in some examples.

FIG. 8 shows a flow chart outlining a decoding process according to some embodiments of the disclosure.

FIG. 9 shows a flow chart outlining an encoding process according to some embodiments of the disclosure.

FIG. 10 is a schematic illustration of a computer system in accordance with an embodiment.

### DETAILED DESCRIPTION OF EMBODIMENTS

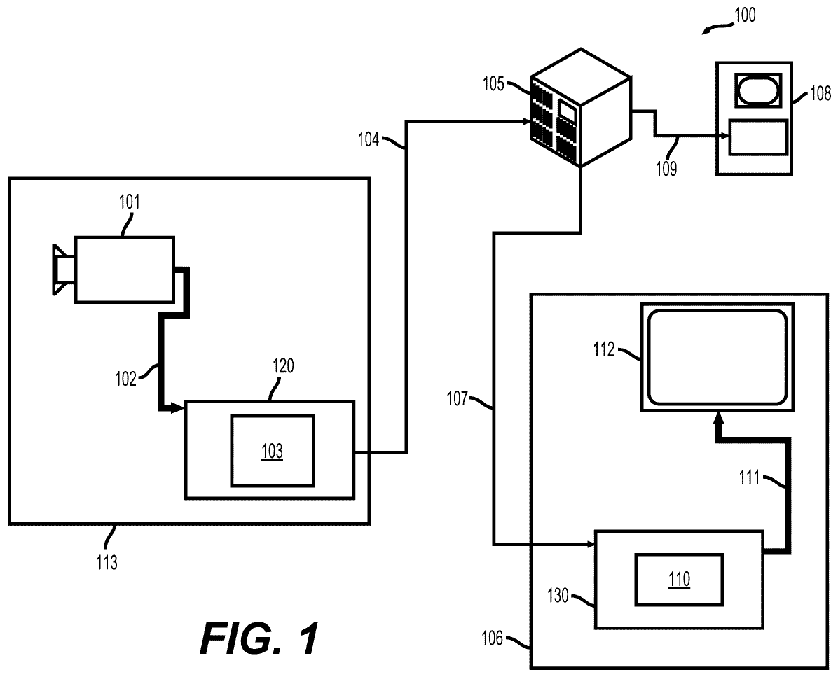

FIG. 1 shows a block diagram of a video processing system (100) in some examples. The video processing system (100) is an example of an application for the disclosed subject matter, a video encoder and a video decoder in a streaming environment. The disclosed subject matter can be equally applicable to other video enabled applications, including, for example, video conferencing, digital TV, streaming services, storing of compressed video on digital media including CD, DVD, memory stick and the like, and so on.

The video processing system (100) includes a capture subsystem (113), that can include a video source (101), for example a digital camera, creating for example a stream of video pictures (102) that are uncompressed. In an example, the stream of video pictures (102) includes samples that are taken by the digital camera. The stream of video pictures (102), depicted as a bold line to emphasize a high data volume when compared to encoded video data (104) (or coded video bitstreams), can be processed by an electronic device (120) that includes a video encoder (103) coupled to the video source (101). The video encoder (103) can include hardware, software, or a combination thereof to enable or implement aspects of the disclosed subject matter as described in more detail below. The encoded video data (104) (or encoded video bitstream), depicted as a thin line to emphasize the lower data volume when compared to the stream of video pictures (102), can be stored on a streaming server (105) for future use. One or more streaming client subsystems, such as client subsystems (106) and (108) in FIG. 1 can access the streaming server (105) to retrieve copies (107) and (109) of the encoded video data (104). A client subsystem (106) can include a video decoder (110), for example, in an electronic device (130). The video decoder (110) decodes the incoming copy (107) of the encoded video data and creates an outgoing stream of video pictures (111) that can be rendered on a display (112) (e.g., display screen) or other rendering device (not depicted). In some streaming systems, the encoded video data (104), (107), and (109) (e.g., video bitstreams) can be encoded according to certain video coding/compression standards. Examples of those standards include ITU-T Recommendation H.265. In an example, a video coding standard under development is informally known as Versatile Video Coding (VVC). The disclosed subject matter may be used in the context of VVC.

It is noted that the electronic devices (120) and (130) can include other components (not shown). For example, the electronic device (120) can include a video decoder (not shown) and the electronic device (130) can include a video encoder (not shown) as well.

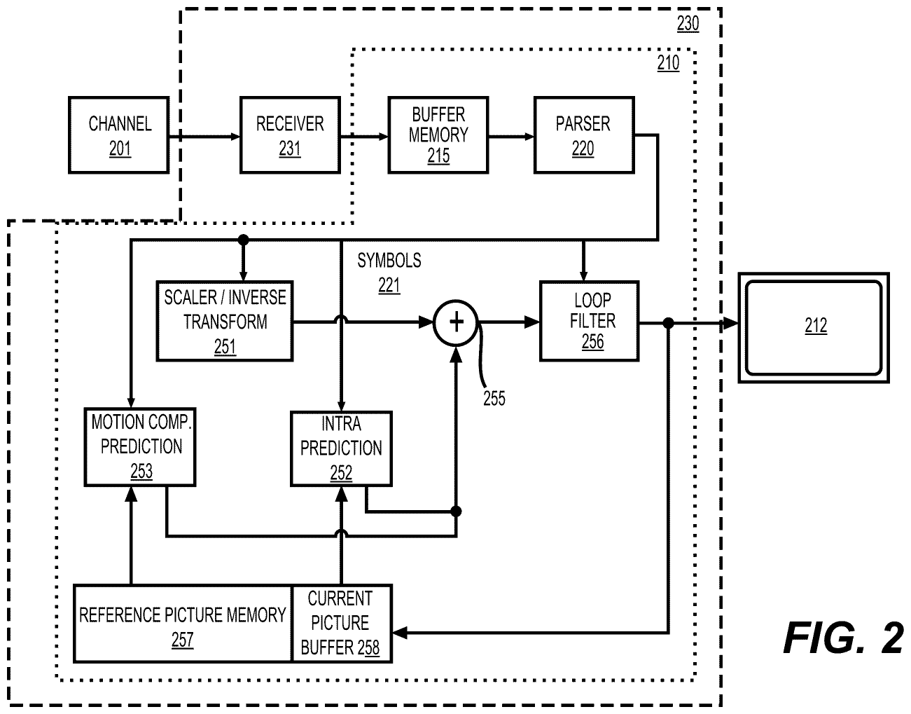

FIG. 2 shows an exemplary block diagram of a video decoder (210). The video decoder (210) can be included in an electronic device (230). The electronic device (230) can include a receiver (231) (e.g., receiving circuitry). The video decoder (210) can be used in the place of the video decoder (110) in the FIG. 1 example.

The receiver (231) may receive one or more coded video sequences, included in a bitstream for example, to be decoded by the video decoder (210). In an embodiment, one coded video sequence is received at a time, where the decoding of each coded video sequence is independent from the decoding of other coded video sequences. The coded video sequence may be received from a channel (201), which may be a hardware/software link to a storage device which stores the encoded video data. The receiver (231) may receive the encoded video data with other data, for example, coded audio data and/or ancillary data streams, that may be forwarded to their respective using entities (not depicted). The receiver (231) may separate the coded video sequence from the other data. To combat network jitter, a buffer memory (215) may be coupled in between the receiver (231) and an entropy decoder/parser (220) (“parser (220)” henceforth). In certain applications, the buffer memory (215) is part of the video decoder (210). In others, it can be outside of the video decoder (210) (not depicted). In still others, there can be a buffer memory (not depicted) outside of the video decoder (210), for example to combat network jitter, and in addition another buffer memory (215) inside the video decoder (210), for example to handle playout timing. When the receiver (231) is receiving data from a store/forward device of sufficient bandwidth and controllability, or from an isosynchronous network, the buffer memory (215) may not be needed, or can be small. For use on best effort packet networks such as the Internet, the buffer memory (215) may be required, can be comparatively large and can be advantageously of adaptive size, and may at least partially be implemented in an operating system or similar elements (not depicted) outside of the video decoder (210).

The video decoder (210) may include the parser (220) to reconstruct symbols (221) from the coded video sequence. Categories of those symbols include information used to manage operation of the video decoder (210), and potentially information to control a rendering device such as a render device (212) (e.g., a display screen) that is not an integral part of the electronic device (230) but can be coupled to the electronic device (230), as shown in FIG. 2. The control information for the rendering device(s) may be in the form of Supplemental Enhancement Information (SEI) messages or Video Usability Information (VUI) parameter set fragments (not depicted). The parser (220) may parse/entropy-decode the coded video sequence that is received. The coding of the coded video sequence can be in accordance with a video coding technology or standard, and can follow various principles, including variable length coding, Huffman coding, arithmetic coding with or without context sensitivity, and so forth. The parser (220) may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser (220) may also extract from the coded video sequence information such as transform coefficients, quantizer parameter values, motion vectors, and so forth.

The parser (220) may perform an entropy decoding/parsing operation on the video sequence received from the buffer memory (215), so as to create symbols (221).

Reconstruction of the symbols (221) can involve multiple different units depending on the type of the coded video picture or parts thereof (such as: inter and intra picture, inter and intra block), and other factors. Which units are involved, and how, can be controlled by subgroup control information parsed from the coded video sequence by the parser (220). The flow of such subgroup control information between the parser (220) and the multiple units below is not depicted for clarity.

Beyond the functional blocks already mentioned, the video decoder (210) can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler/inverse transform unit (251). The scaler/inverse transform unit (251) receives a quantized transform coefficient as well as control information, including which transform to use, block size, quantization factor, quantization scaling matrices, etc. as symbol(s) (221) from the parser (220). The scaler/inverse transform unit (251) can output blocks comprising sample values, that can be input into aggregator (255).

In some cases, the output samples of the scaler/inverse transform unit (251) can pertain to an intra coded block. The intra coded block is a block that is not using predictive information from previously reconstructed pictures, but can use predictive information from previously reconstructed parts of the current picture. Such predictive information can be provided by an intra picture prediction unit (252). In some cases, the intra picture prediction unit (252) generates a block of the same size and shape of the block under reconstruction, using surrounding already reconstructed information fetched from the current picture buffer (258). The current picture buffer (258) buffers, for example, partly reconstructed current picture and/or fully reconstructed current picture. The aggregator (255), in some cases, adds, on a per sample basis, the prediction information the intra prediction unit (252) has generated to the output sample information as provided by the scaler/inverse transform unit (251).

In other cases, the output samples of the scaler/inverse transform unit (251) can pertain to an inter coded, and potentially motion compensated, block. In such a case, a motion compensation prediction unit (253) can access reference picture memory (257) to fetch samples used for prediction. After motion compensating the fetched samples in accordance with the symbols (221) pertaining to the block, these samples can be added by the aggregator (255) to the output of the scaler/inverse transform unit (251) (in this case called the residual samples or residual signal) so as to generate output sample information. The addresses within the reference picture memory (257) from where the motion compensation prediction unit (253) fetches prediction samples can be controlled by motion vectors, available to the motion compensation prediction unit (253) in the form of symbols (221) that can have, for example X, Y, and reference picture components. Motion compensation also can include interpolation of sample values as fetched from the reference picture memory (257) when sub-sample exact motion vectors are in use, motion vector prediction mechanisms, and so forth.

The output samples of the aggregator (255) can be subject to various loop filtering techniques in the loop filter unit (256). Video compression technologies can include in-loop filter technologies that are controlled by parameters included in the coded video sequence (also referred to as coded video bitstream) and made available to the loop filter unit (256) as symbols (221) from the parser (220). Video compression can also be responsive to meta-information obtained during the decoding of previous (in decoding order) parts of the coded picture or coded video sequence, as well as responsive to previously reconstructed and loop-filtered sample values.

The output of the loop filter unit (256) can be a sample stream that can be output to the render device (212) as well as stored in the reference picture memory (257) for use in future inter-picture prediction.

Certain coded pictures, once fully reconstructed, can be used as reference pictures for future prediction. For example, once a coded picture corresponding to a current picture is fully reconstructed and the coded picture has been identified as a reference picture (by, for example, the parser (220)), the current picture buffer (258) can become a part of the reference picture memory (257), and a fresh current picture buffer can be reallocated before commencing the reconstruction of the following coded picture.

The video decoder (210) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile can select certain tools as the only tools available for use under that profile from all the tools available in the video compression technology or standard. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an embodiment, the receiver (231) may receive additional (redundant) data with the encoded video. The additional data may be included as part of the coded video sequence(s). The additional data may be used by the video decoder (210) to properly decode the data and/or to more accurately reconstruct the original video data. Additional data can be in the form of, for example, temporal, spatial, or signal noise ratio (SNR) enhancement layers, redundant slices, redundant pictures, forward error correction codes, and so on.

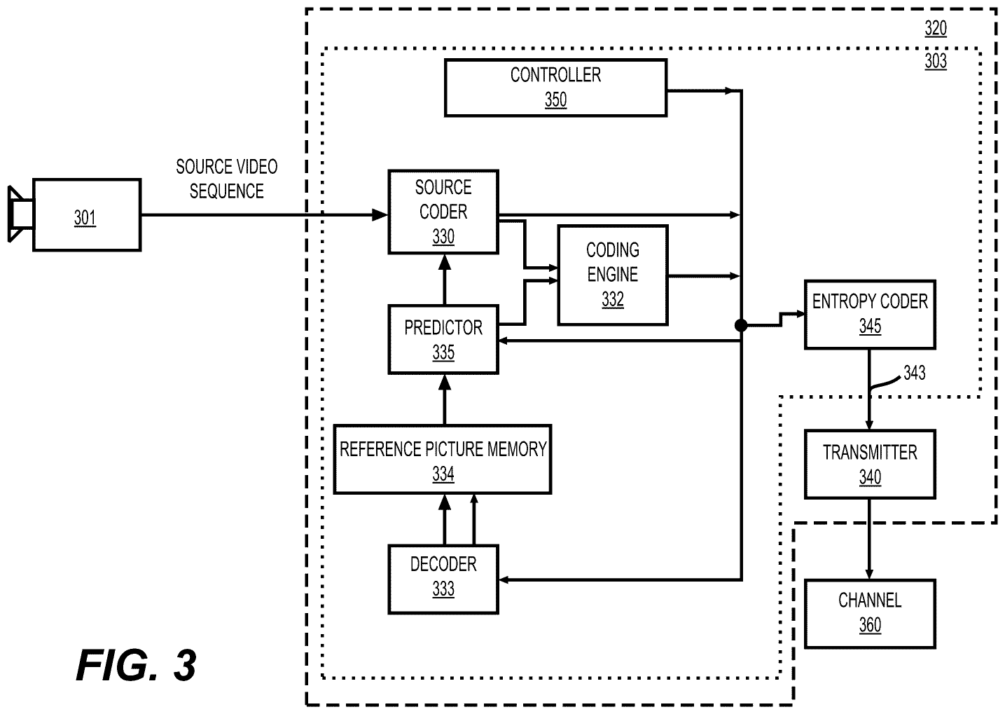

FIG. 3 shows an exemplary block diagram of a video encoder (303). The video encoder (303) is included in an electronic device (320). The electronic device (320) includes a transmitter (340) (e.g., transmitting circuitry). The video encoder (303) can be used in the place of the video encoder (103) in the FIG. 1 example.

The video encoder (303) may receive video samples from a video source (301) (that is not part of the electronic device (320) in the FIG. 3 example) that may capture video image(s) to be coded by the video encoder (303). In another example, the video source (301) is a part of the electronic device (320).

The video source (301) may provide the source video sequence to be coded by the video encoder (303) in the form of a digital video sample stream that can be of any suitable bit depth (for example: 8 bit, 10 bit, 12 bit, . . . ), any colorspace (for example, BT.601 Y CrCB, RGB, . . . ), and any suitable sampling structure (for example Y CrCb 4:2:0, Y CrCb 4:4:4). In a media serving system, the video source (301) may be a storage device storing previously prepared video. In a videoconferencing system, the video source (301) may be a camera that captures local image information as a video sequence. Video data may be provided as a plurality of individual pictures that impart motion when viewed in sequence. The pictures themselves may be organized as a spatial array of pixels, wherein each pixel can comprise one or more samples depending on the sampling structure, color space, etc. in use. The description below focuses on samples.

According to an embodiment, the video encoder (303) may code and compress the pictures of the source video sequence into a coded video sequence (343) in real time or under any other time constraints as required. Enforcing appropriate coding speed is one function of a controller (350). In some embodiments, the controller (350) controls other functional units as described below and is functionally coupled to the other functional units. The coupling is not depicted for clarity. Parameters set by the controller (350) can include rate control related parameters (picture skip, quantizer, lambda value of rate-distortion optimization techniques, . . . ), picture size, group of pictures (GOP) layout, maximum motion vector search range, and so forth. The controller (350) can be configured to have other suitable functions that pertain to the video encoder (303) optimized for a certain system design.

In some embodiments, the video encoder (303) is configured to operate in a coding loop. As an oversimplified description, in an example, the coding loop can include a source coder (330) (e.g., responsible for creating symbols, such as a symbol stream, based on an input picture to be coded, and a reference picture(s)), and a (local) decoder (333) embedded in the video encoder (303). The decoder (333) reconstructs the symbols to create the sample data in a similar manner as a (remote) decoder also would create. The reconstructed sample stream (sample data) is input to the reference picture memory (334). As the decoding of a symbol stream leads to bit-exact results independent of decoder location (local or remote), the content in the reference picture memory (334) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is used in some related arts as well.

The operation of the “local” decoder (333) can be the same as a “remote” decoder, such as the video decoder (210), which has already been described in detail above in conjunction with FIG. 2. Briefly referring also to FIG. 2, however, as symbols are available and encoding/decoding of symbols to a coded video sequence by an entropy coder (345) and the parser (220) can be lossless, the entropy decoding parts of the video decoder (210), including the buffer memory (215), and parser (220) may not be fully implemented in the local decoder (333).

In an embodiment, a decoder technology except the parsing/entropy decoding that is present in a decoder is present, in an identical or a substantially identical functional form, in a corresponding encoder. Accordingly, the disclosed subject matter focuses on decoder operation. The description of encoder technologies can be abbreviated as they are the inverse of the comprehensively described decoder technologies. In certain areas a more detail description is provided below.

During operation, in some examples, the source coder (330) may perform motion compensated predictive coding, which codes an input picture predictively with reference to one or more previously coded picture from the video sequence that were designated as “reference pictures.” In this manner, the coding engine (332) codes differences between pixel blocks of an input picture and pixel blocks of reference picture(s) that may be selected as prediction reference(s) to the input picture.

The local video decoder (333) may decode coded video data of pictures that may be designated as reference pictures, based on symbols created by the source coder (330). Operations of the coding engine (332) may advantageously be lossy processes. When the coded video data may be decoded at a video decoder (not shown in FIG. 3), the reconstructed video sequence typically may be a replica of the source video sequence with some errors. The local video decoder (333) replicates decoding processes that may be performed by the video decoder on reference pictures and may cause reconstructed reference pictures to be stored in the reference picture memory (334). In this manner, the video encoder (303) may store copies of reconstructed reference pictures locally that have common content as the reconstructed reference pictures that will be obtained by a far-end video decoder (absent transmission errors).

The predictor (335) may perform prediction searches for the coding engine (332). That is, for a new picture to be coded, the predictor (335) may search the reference picture memory (334) for sample data (as candidate reference pixel blocks) or certain metadata such as reference picture motion vectors, block shapes, and so on, that may serve as an appropriate prediction reference for the new pictures. The predictor (335) may operate on a sample block-by-pixel block basis to find appropriate prediction references. In some cases, as determined by search results obtained by the predictor (335), an input picture may have prediction references drawn from multiple reference pictures stored in the reference picture memory (334).

The controller (350) may manage coding operations of the source coder (330), including, for example, setting of parameters and subgroup parameters used for encoding the video data.

Output of all aforementioned functional units may be subjected to entropy coding in the entropy coder (345). The entropy coder (345) translates the symbols as generated by the various functional units into a coded video sequence, by applying lossless compression to the symbols according to technologies such as Huffman coding, variable length coding, arithmetic coding, and so forth.

The transmitter (340) may buffer the coded video sequence(s) as created by the entropy coder (345) to prepare for transmission via a communication channel (360), which may be a hardware/software link to a storage device which would store the encoded video data. The transmitter (340) may merge coded video data from the video encoder (303) with other data to be transmitted, for example, coded audio data and/or ancillary data streams (sources not shown).

The controller (350) may manage operation of the video encoder (303). During coding, the controller (350) may assign to each coded picture a certain coded picture type, which may affect the coding techniques that may be applied to the respective picture. For example, pictures often may be assigned as one of the following picture types:

An Intra Picture (I picture) may be coded and decoded without using any other picture in the sequence as a source of prediction. Some video codecs allow for different types of intra pictures, including, for example Independent Decoder Refresh (“IDR”) Pictures.

A predictive picture (P picture) may be coded and decoded using intra prediction or inter prediction using a motion vector and reference index to predict the sample values of each block.

A bi-directionally predictive picture (B Picture) may be coded and decoded using intra prediction or inter prediction using two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (303) may perform coding operations according to a predetermined video coding technology or standard, such as ITU-T Rec. H.265. In its operation, the video encoder (303) may perform various compression operations, including predictive coding operations that exploit temporal and spatial redundancies in the input video sequence. The coded video data, therefore, may conform to a syntax specified by the video coding technology or standard being used.

In an embodiment, the transmitter (340) may transmit additional data with the encoded video. The source coder (330) may include such data as part of the coded video sequence. Additional data may comprise temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

In some embodiments, a bi-prediction technique can be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture can be coded by a first motion vector that points to a first reference block in the first reference picture, and a second motion vector that points to a second reference block in the second reference picture. The block can be predicted by a combination of the first reference block and the second reference block.

Further, a merge mode technique can be used in the inter-picture prediction to improve coding efficiency.

According to some embodiments of the disclosure, predictions, such as inter-picture predictions and intra-picture predictions, are performed in the unit of blocks. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU can be recursively quadtrec split into one or multiple coding units (CUs). For example, a CTU of 64×64 pixels can be split into one CU of 64×64 pixels, or 4 CUs of 32×32 pixels, or 16 CUs of 16×16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an embodiment, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

It is noted that the video encoders (103) and (303), and the video decoders (110) and (210) can be implemented using any suitable technique. In an embodiment, the video encoders (103) and (303) and the video decoders (110) and (210) can be implemented using one or more integrated circuits. In another embodiment, the video encoders (103) and (303), and the video decoders (110) and (210) can be implemented using one or more processors that execute software instructions.

Aspects of the disclosure provide techniques of non-uniform classification for filter classifier, such as adaptive loop filter (ALF) classifier.

In some examples (e.g., VVC), adaptive loop filter (ALF) and cross component adaptive loop filter (CC-ALF) are used in video coding.

In some examples, ALF with block-based filter adaption can be applied by encoders/decoders to reduce artifacts. Two filter shapes for block-based ALF can be used in VVC. For example, a 7×7 diamond shape is applied for the luma component, and a 5×5 diamond shape is applied for the chroma component. In an example, one among up to 25 filters is selected for each 4×4 block based on the direction and activity of local gradients. According to the directionality and activity of local gradient, each 4×4 block is classified and categorized into one of the 25 classes. Each class can have its own filter coefficient assignment. In some examples, before filtering, a geometric transformation, such as 90-degree rotation, diagonal or vertical flip, can be applied to the filter shape depending on the gradient values calculated for the block. The geometric transformation of the filter shape is equivalent to applying these transformations to the samples in filter support region. The geometric transform can perform ALF for each block by aligning filter with the directionality of the block.

In some examples, in addition to the luma 4×4 block-level filter adaptation, CTU-level filter adaptation is also supported in ALF. For example, each CTU can use a filter set calculated from the current slice or one of the filter sets signaled at already coded slices or one of the 16 offline trained filter sets. Within each CTU, the selected filter set can be applied to each 4×4 block. Filter coefficients and clipping indices are carried in ALF adaptation parameter sets (APSs). An ALF APS can include up to 8 chroma filters and one luma filter set with up to 25 filters. In an example, an index i_{c} is also included for each of the 25 luma classes. By merging different classes, the number of filter coefficient's bit could be reduced.

CC-ALF uses the luma sample values to refine the chroma sample values within the ALF process. The linear filtering operation takes the luma sample as input and generates the correction values for the chroma sample values. The correction is generated independently for each chroma component.

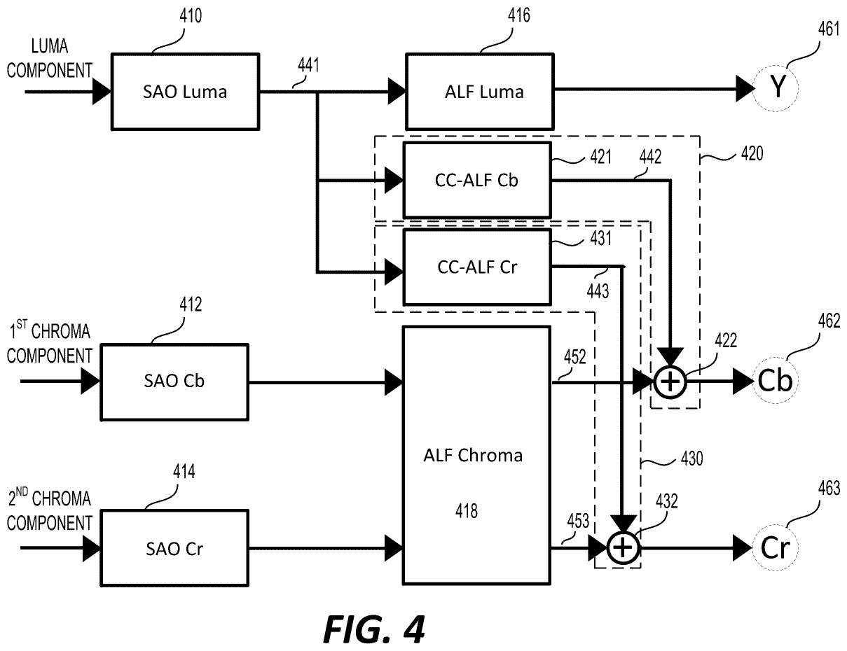

FIG. 4 shows cross-component filters (e.g., CC-ALFs) used to generate chroma components according to an embodiment of the disclosure. In some examples, FIG. 4 shows filtering processes for a first chroma component (e.g., a first chroma CB), a second chroma component (e.g., a second chroma CB), and a luma component (e.g., a luma CB). The luma component can be filtered by a sample adaptive offset (SAO) filter (410) to generate a SAO filtered luma component (441). The SAO filtered luma component (441) can be further filtered by an ALF luma filter (416) to become a filtered luma CB (461) (e.g., ‘Y’).

The first chroma component can be filtered by a SAO filter (412) and an ALF chroma filter (418) to generate a first intermediate component (452). Further, the SAO filtered luma component (441) can be filtered by a cross-component filter (e.g., CC-ALF) (421) for the first chroma component to generate a second intermediate component (442). Subsequently, a filtered first chroma component (462) (e.g., ‘Cb’) can be generated based on at least one of the second intermediate component (442) and the first intermediate component (452). In an example, the filtered first chroma component (462) (e.g., ‘Cb’) can be generated by combining the second intermediate component (442) and the first intermediate component (452) with an adder (422). The cross-component adaptive loop filtering process for the first chroma component can include a step performed by the CC-ALF (421) and a step performed by, for example, the adder (422).

The above description can be adapted to the second chroma component. The second chroma component can be filtered by a SAO filter (414) and the ALF chroma filter (418) to generate a third intermediate component (453). Further, the SAO filtered luma component (441) can be filtered by a cross-component filter (e.g., a CC-ALF) (431) for the second chroma component to generate a fourth intermediate component (443). Subsequently, a filtered second chroma component (463) (e.g., ‘Cr’) can be generated based on at least one of the fourth intermediate component (443) and the third intermediate component (453). In an example, the filtered second chroma component (463) (e.g., ‘Cr’) can be generated by combining the fourth intermediate component (443) and the third intermediate component (453) with an adder (432). In an example, the cross-component adaptive loop filtering process for the second chroma component can include a step performed by the CC-ALF (431) and a step performed by, for example, the adder (432).

A cross-component filter (e.g., the CC-ALF (421), the CC-ALF (431)) can operate by applying a linear filter having any suitable filter shape to the luma component (or a luma channel) to refine each chroma component (e.g., the first chroma component, the second chroma component).

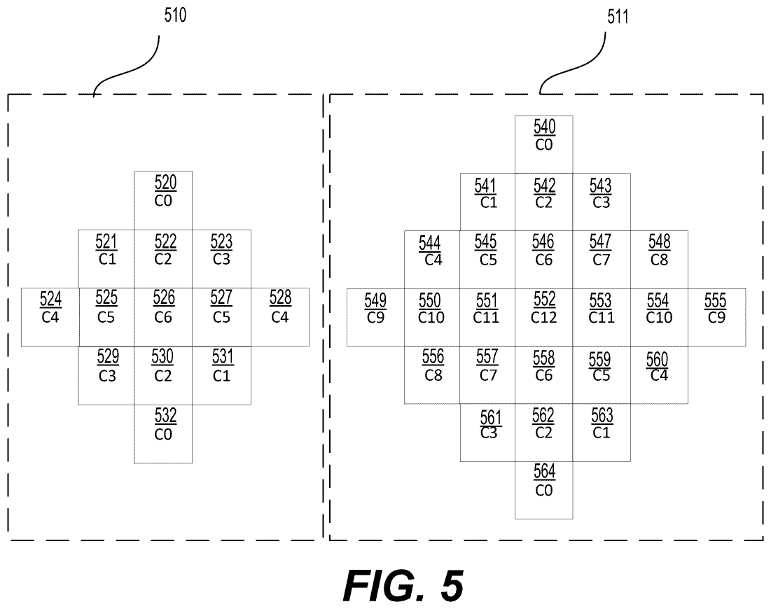

An ALF can have any suitable shape and size. FIG. 5 shows a diagram of two ALF filter shapes in some examples. Referring to FIG. 5, ALFs (510)-(511) have a diamond shape, such as a 5×5 diamond-shape for the ALF (510) and a 7×7 diamond-shape for the ALF (511). In the ALF (510), elements (520)-(532) form a diamond shape and can be used in the filtering process. Seven values (e.g., C0-C6) can be used for the elements (520)-(532). In the ALF (511), elements (540)-(564) forms a diamond shape and can be used in the filtering process. Thirteen values (e.g., C0-C12) can be used for the elements (540)-(564).

Referring to FIG. 5, in some examples, the two ALFs (510)-(511) with the diamond filter shape are used. The 5×5 diamond-shaped filter (510) can be applied for chroma components (e.g., chroma blocks, chroma CBs), and the 7×7 diamond-shaped filter (511) can be applied for a luma component (e.g., a luma block, a luma CB). Other suitable shape(s) and size(s) can be used in the ALF. For example, a 9×9 diamond-shaped filter can be used.

Filter coefficients at locations indicated by the values (e.g., C0-C6 in (510) or C0-C12 in (520)) can be non-zero. Further, when the ALF includes a clipping function, clipping values at the locations can be non-zero.

For block classification of a luma component, a 4×4 block (or luma block, luma CB) can be categorized or classified as one of multiple (e.g., 25) classes. A classification index C can be derived based on a directionality parameter D and a quantized value Â of an activity value A using Eq. (1).

$$C = 5 D + \hat{A} \qquad Eq . ( 1 )$$

To calculate the directionality parameter D and the quantized value Â, gradients gᵥ, gₕ, g_{d1}, and g_{d2} of a vertical, a horizontal, and two diagonal directions (e.g., d1 and d2), respectively, can be calculated using 1-D Laplacian as follows.

$${g}_{v} = {\sum }_{k = i - 2}^{i + 3} {\sum }_{l = j - 2}^{j + 3} {V}_{k , l} , {V}_{k , l} = \vert 2 R ( k , l ) - R ( k , l - 1 ) - R ( k , l + 1 ) \vert \qquad Eq . ( 2 )$$

$${g}_{h} = {\sum }_{k = i - 2}^{i + 3} {\sum }_{l = j - 2}^{j + 3} {H}_{k , l} , \\ {H}_{k , l} = \vert 2 R ( k , l ) - R ( k - 1 , l ) - R ( k + 1 , l ) \vert \qquad Eq . ( 3 )$$

$${g}_{d 1} = {\sum }_{k = i - 2}^{i + 3} {\sum }_{l = j - 3}^{j + 3} D {1}_{k , l} , \\ D {1}_{k , l} = \vert 2 R ( k , l ) - R ( k - 1 , l - 1 ) - R ( k + 1 , l + 1 ) \vert \qquad Eq . ( 4 )$$

$${g}_{d 2} = {\sum }_{k = i - 2}^{i + 3} {\sum }_{j = j - 2}^{j + 3} D {2}_{k , l} , \\ D {2}_{k , l} = \vert 2 R ( k , l ) - R ( k - 1 , l + 1 ) - R ( k + 1 , l - 1 ) \vert \qquad Eq . ( 5 )$$

where indices i and j refer to coordinates of an upper left sample within the 4×4 block and R(k, l) indicates a reconstructed sample at a coordinate (k, l). The directions (e.g., d1 and d2) can refer to 2 diagonal directions.

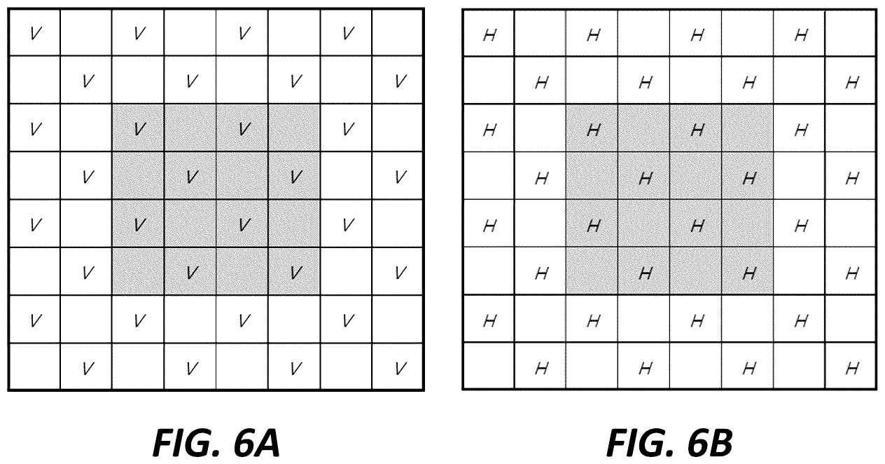

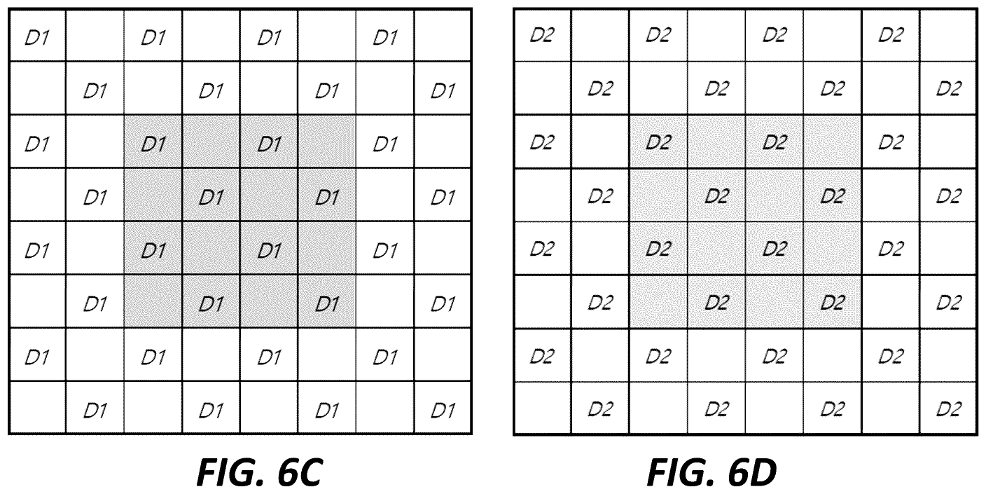

To reduce complexity of the block classification described above, a subsampled 1-D Laplacian calculation can be applied. FIGS. 6A-6D show examples of subsampled positions used for calculating the gradients gᵥ, gₕ, g_{d1}, and g_{d2} of the vertical (FIG. 6A), the horizontal (FIG. 6B), and the two diagonal directions d1 (FIG. 6C) and d2 (FIG. 6D), respectively. The same subsampled positions can be used for gradient calculation of the different directions. In FIG. 6A, labels ‘V’ show the subsampled positions to calculate the vertical gradient gr. In FIG. 6B, labels ‘H’ show the subsampled positions to calculate the horizontal gradient gₕ. In FIG. 6C, labels ‘D1’ show the subsampled positions to calculate the d1 diagonal gradient g_{d1}. In FIG. 6D, labels ‘D2’ show the subsampled positions to calculate the d2 diagonal gradient g_{d2}.

A maximum value

$${g}_{h , v}^{max}$$

and a minimum value

$${g}_{h , v}^{min}$$

of the gradients of horizontal and vertical directions gᵥ and gₕ can be set as:

$${g}_{h , v}^{max} = max ( {g}_{h} , {g}_{v} ) , {g}_{h , v}^{min} = min ( {g}_{h} , {g}_{v} ) \qquad Eq . ( 6 )$$

A maximum value

$${g}_{d 1 , d 2}^{max}$$

and a minimum value

$${g}_{d 1 , d 2}^{min}$$

of the gradients of two diagonal directions g_{d1} and g_{d2} can be set as:

$${g}_{d 1 , d 2}^{max} = max ( {g}_{d 1} , {g}_{d 2} ) , {g}_{d 1 , d 2}^{min} = min ( {g}_{d 1} , {g}_{d 2} ) \qquad Eq . ( 7 )$$

The directionality parameter D can be derived based on the above values and two thresholds t₁ and t₂ as below.
Step 1.

$$If {g}_{h , v}^{max} \leq {t}_{1} \cdot {g}_{h , v}^{min} and \qquad ( 1 )$$

$${g}_{d 1 , d 2}^{max} \leq {t}_{1} \cdot {g}_{d 1 , d 2}^{min} \qquad ( 2 )$$

are true, D is set to 0.
Step 2.

$$If {g}_{h , v}^{max} / {g}_{h , v}^{min} > {g}_{d 1 , d 2}^{max} / {g}_{d 1 , d 2}^{min} ,$$

continue to Step 3; otherwise continue to Step 4.
Step 3.

$$If {g}_{h , v}^{max} > {t}_{2} \cdot {g}_{h , v}^{min} ,$$

D is set to 2, otherwise D is set to 1.
Step 4.

$$If {g}_{d 1 , d 2}^{max} > {t}_{2} \cdot {g}_{d 1 , d 2}^{min} ,$$

D is set to 4; otherwise D is set to 3.

The activity value A can be calculated as:

$$A = {\sum }_{k = i - 2}^{i + 3} {\sum }_{l = j - 2}^{j + 3} ( {V}_{k , l} + {H}_{k , l} ) = {g}_{v} + {g}_{h} \qquad Eq . ( 8 )$$

A can be further quantized to a range of 0 to 4, inclusively, and the quantized value is denoted as Â.

For chroma components in a picture, no block classification is applied, and thus a single set of ALF coefficients can be applied for each chroma component.

Geometric transformations can be applied to filter coefficients and corresponding filter clipping values (also referred to as clipping values). Before filtering a block (e.g., a 4×4 luma block), geometric transformations such as rotation or diagonal and vertical flipping can be applied to the filter coefficients f(k, l) and the corresponding filter clipping values c(k, l), for example, depending on gradient values (e.g., gr, gₕ, g_{d1}, and/or g_{d2}) calculated for the block. The geometric transformations applied to the filter coefficients f(k, l) and the corresponding filter clipping values c(k, l) can be equivalent to applying the geometric transformations to samples in a region supported by the filter. The geometric transformations can make different blocks to which an ALF is applied more similar by aligning the respective directionality.

Three geometric transformations, including a diagonal flip, a vertical flip, and a rotation can be performed as described by Eqs. (9)-(11), respectively.

$${f}_{D} ( k , l ) = f ( l , k ) , {c}_{D} ( k , l ) = c ( l , k ) \qquad Eq . ( 9 )$$

$${f}_{V} ( k , l ) = f ( k , K - l - 1 ) , {c}_{V} ( k , l ) = c ( k , K - l - 1 ) \qquad Eq . ( 10 )$$

$${f}_{R} ( k , l ) = f ( K - l - 1 , k ) , {c}_{R} ( k , l ) = c ( K - l - 1 , k ) \qquad Eq . ( 11 )$$

where K is a size of the ALF or the filter, and 0≤k, 1≤K-1 are coordinates of coefficients. For example, a location (0,0) is at an upper left corner and a location (K-1, K-1) is at a lower right corner of the filter f or a clipping value matrix (or clipping matrix) c. The transformations can be applied to the filter coefficients f(k, l) and the clipping values c(k, l) depending on the gradient values calculated for the block. An example of a relationship between the transformation and the four gradients are summarized in Table 1.

TABLE 1
Mapping of the gradient calculated
for a block and the transformation

| Gradient values | Transformation |
|---|---|
| g_{d2} < g_{d1} and gₕ < gᵥ | No transformation |
| g_{d2} < g_{d1} and gᵥ < gₕ | Diagonal flip |
| g_{d1} < g_{d2} and gₕ < gᵥ | Vertical flip |
| g_{d1} < g_{d2} and gᵥ < gₕ | Rotation |

For the filtering process, at decoder side, when ALF is enabled for a CTB, each sample R(i,j) within the CU is filtered, resulting in sample value R′(i,j) as shown Eq. (12):

$${R}^{′} ( i , j ) = R ( i , j ) + ( ( {\sum }_{k \neq 0} {\sum }_{l \neq 0} f ( k , l ) \times K ( R ( i + k , j + l ) - R ( i , j ) , c ( k , l ) ) + 64 ) ≫ 7 ) \qquad Eq . ( 12 )$$

where f(k, l) denotes the decoded filter coefficients, K(x, y) is the clipping function and c(k, l) denotes the decoded clipping parameters. The variable k and l vary between −L/2 and L/2 where L denotes the filter length. The clipping function K(x, y)=min (y, max(−y, x)) which corresponds to the function Clip3 (−y, y,x). The clipping operation introduces non-linearity to make ALF more efficient by reducing the impact of neighbor sample values that are too different with the current sample value.

In some examples (e.g., ECM), some modifications can be made to ALF. For example, ALF gradient subsampling and ALF virtual boundary processing are removed. In another example, block size for classification is reduced from 4×4 to 2×2. Further, filter size for both luma and chroma, for which ALF coefficients are signalled, is increased to 9×9.

In some examples, a technique that is referred to as ALF with fixed filters is used. To filter a luma sample, three different classifiers (C₀, C₁ and C₂) and three different sets of filters (F₀, F₁ and F₂) are used. Sets F₀ and F₁ contain fixed filters, with coefficients trained for classifiers C₀ and C₁. Coefficients of filters in F₂ are signalled. Which filter from a set F₁ is used for a given sample is decided by a class Cᵢ assigned to this sample using classifier Cᵢ.

In some examples, (e.g., ECM8), for classification, a class Cᵢ is assigned to each 2×2 block based on directionality Dᵢ and activity Âᵢ as shown in Eq. (13)

$${C}_{i} = {\hat{A}}_{i} * {M}_{D , i} + {D}_{i} \qquad Eq . ( 13 )$$

where M_{D,i} represents the total number of directionalities Dᵢ.

In some examples, values of the horizontal, vertical, and two diagonal gradients are calculated for each sample using 1-D Laplacian. The sum of the sample gradients within a 4×4 window that covers the target 2×2 block is used for classifier C₀ and the sum of sample gradients within a 12×12 window is used for classifiers C₁ and C₂. The sums of horizontal, vertical and two diagonal gradients are denoted, respectively, as

$${g}_{h}^{i} , {g}_{v}^{i} , {g}_{d 1}^{i} and {g}_{d 2}^{i} .$$

The directionality Dᵢ is determined by comparing

$${r}_{h , v}^{i} and {r}_{d 1 , d 2}^{i}$$

### in Eq. (14)

$${r}_{h , v}^{i} = \frac{max ( {g}_{h}^{i} , {g}_{v}^{i} )}{min ( {g}_{h}^{i} , {g}_{v}^{i} )} , {r}_{d 1 , d 2}^{i} = \frac{max ( {g}_{d 1}^{i} , {g}_{d 2}^{i} )}{min ( {g}_{d 1}^{i} , {g}_{d 2}^{i} )} \qquad Eq . ( 14 )$$

with a set of thresholds. The directionality D₂ is derived as in VVC using thresholds 2 and 4.5. For D₀ and D₁, horizontal/vertical edge strength

$${E}_{H V}^{i}$$

and diagonal edge strength

$${E}_{D}^{i}$$

are calculated first. Thresholds Th=[1.25, 1.5, 2, 3, 4.5, 8] are used. Edge strength

$${E}_{H V}^{i}$$

is 0 if

$${r}_{h , v}^{i} \leq Th [ 0 ] ;$$

otherwise,

$${E}_{H V}^{i}$$

is the maximum integer such that

$${r}_{h , v}^{i} > T h [ {E}_{H V}^{i} - 1 ] .$$

Edge strength

$${E}_{D}^{i}$$

is 0 if

$${r}_{d 1 , d 2}^{i} \leq T h [ 0 ] ;$$

otherwise,

$${E}_{D}^{i}$$

is the maximum integer such that

$${r}_{d 1 , d 2}^{i} > T h [ {E}_{D}^{i} - 1 ] .$$

### When

$${r}_{h , v}^{i} > {r}_{d 1 , d 2}^{i} ,$$

i.e., horizontal/vertical edges are dominant, the Dᵢ is derived by using Table 2 (a); otherwise, diagonal edges are dominant, the Dᵢ is derived by using Table 2 (b).

TABLE 1
Mapping of E_{D}ⁱ and E_{HV}ⁱ to Dᵢ

| (a) | | | | | | | | (b) | | | | | | | |
|---|---|---|---|---|---|---|---|---|---|---|---|---|---|---|---|
| | ${E}_{D}^{i}$ | | | | | | | | ${E}_{HV}^{i}$ | | | | | | |
| ${E}_{HV}^{i}$ | 0 | 1 | 2 | 3 | 4 | 5 | 6 | ${E}_{D}^{i}$ | 0 | 1 | 2 | 3 | 4 | 5 | 6 |
| 0 | 0 | 0 | 0 | 0 | 0 | 0 | 0 | 0 | 28 | 0 | 0 | 0 | 0 | 0 | 0 |
| 1 | 1 | 2 | 0 | 0 | 0 | 0 | 0 | 1 | 29 | 30 | 0 | 0 | 0 | 0 | 0 |
| 2 | 3 | 4 | 5 | 0 | 0 | 0 | 0 | 2 | 31 | 32 | 33 | 0 | 0 | 0 | 0 |
| 3 | 6 | 7 | 8 | 9 | 0 | 0 | 0 | 3 | 34 | 35 | 36 | 37 | 0 | 0 | 0 |
| 4 | 10 | 11 | 12 | 13 | 14 | 0 | 0 | 4 | 38 | 39 | 40 | 41 | 42 | 0 | 0 |
| 5 | 15 | 16 | 17 | 18 | 19 | 20 | 0 | 5 | 43 | 44 | 45 | 46 | 47 | 48 | 0 |
| 6 | 21 | 22 | 23 | 24 | 25 | 26 | 27 | 6 | 49 | 50 | 51 | 52 | 53 | 54 | 55 |

To obtain Âᵢ, the sum of vertical and horizontal gradients Aᵢ is mapped to the range of 0 to n, where n is equal to 4 for Â₂ and 15 for Â₀ and Â₁. In an ALF_APS, up to 4 luma filter sets are signalled, each set may have up to 25 filters.

In some examples, alternative 2×2 ALF classifier can be used. Classification in ALF is also extended with an additional alternative classifier. For a signalled luma filter set, a flag is signalled to indicate whether the alternative classifier is applied. Geometrical transformation is not applied to the alternative band classifier. When the band-based classifier is applied, the sum of sample values of a 2×2 luma block is calculated at first. Then the class index is calculated as below,

$${class}_{index} = ( sum \times 25 ) ≫ ( sample bitdepth + 2 ) \qquad Eq . ( 15 )$$

In some examples, for the filtering process, at first, two 13×13 diamond shape fixed filters F₀ and F₁ are applied to derive two intermediate samples R₀(x, y) and R₁ (x, y). After that, F₂ is applied to R₀(x, y), R₁ (x, y), and neighboring samples to derive a filtered sample as

$$\tilde{R} ( x , y ) = R ( x , y ) + [ {\sum }_{i = 0}^{19} {c}_{i} ( {f}_{i , 0} + {f}_{i , 1} ) ] + [ {\sum }_{i = 20}^{21} {c}_{i} {g}_{i} ] \qquad Eq . ( 16 )$$

where f_{i,j} is the clipped difference between a neighboring sample and current sample R(x, y) and gᵢ is the clipped difference between Rᵢ₋₂₀(x, y) and current sample. The filter coefficients cᵢ, i=0, . . . 21, are signalled.

In some examples (e.g., ECM), for ALF, an online-trained filter consists of 4 kinds of filter taps: spatial taps, reconstruction-before-DBF based taps, extended fixed-filter-output based taps and residual taps.

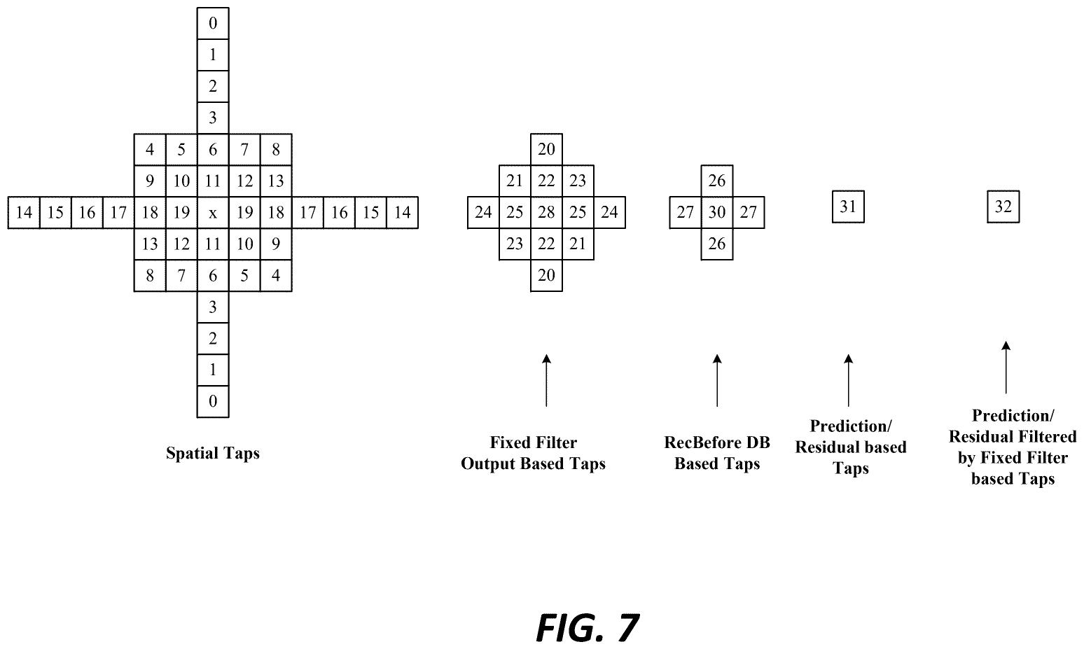

FIG. 7 shows an example of ALF filter shape using residual samples as additional inputs. The spatial taps (i.e. tap #0˜#19) located in a cross shape are followed by 8 offline-filtered taps (i.e. tap #20˜#25, tap #28˜#29), 3 reconstruction-before-DBF based taps (i.e. tap #26, #27, #30) and 2 residual based taps (i.e. tap #31, #32). With this filter shape, a filtered sample is derived as Eq. (17):

$$\tilde{R} ( x , y ) = R ( x , y ) + [ {\sum }_{i = 0}^{19} {c}_{i} ( {f}_{i , 0} + {f}_{i , 1} ) ] + [ {\sum }_{i = 20}^{25} {c}_{i} ( {g}_{i , 0} + {g}_{i , 1} ) ] + [ {\sum }_{i = 26}^{27} {c}_{i} ( {h}_{i , 0} + {h}_{i , 1} ) ] + [ {\sum }_{i = 28}^{29} {c}_{i} {g}_{i} ] + [ {\sum }_{i = 30}^{30} {c}_{i} {h}_{i} ] + [ {\sum }_{i = 31}^{31} {c}_{i} {r}_{i} ] + [ {\sum }_{i = 32}^{32} {c}_{i} rFilter {d}_{i} ] \qquad Eq . ( 17 )$$

where f_{i,j} is the clipped difference between a neighboring sample and current sample R(x, y), gᵢ is the clipped difference between an intermediate sample and current sample R(x, y) and h_{i,j} is the clipped difference between a neighboring sample before DBF and current sample R(x, y). rᵢ is the clipped neighboring residual sample value and rFilteredᵢ is the clipped residual sample filtered by the fixed-filter. For residual samples, the fixed filter reuses the offline fixed filter trained for reconstruction after SAO.

In an adaptation parameter set, a flag is signaled to indicate whether only residual based taps or both residual based taps and residual filtered by fixed filter based taps are used for the ALF.

In some examples, a technique that is referred to as residual based classifier can be used. For example, a third classifier based on luma residual sample values is used. For each 2×2 luma block, the sum of absolute values of the residual samples in a neighboring 8×8 window is calculated, and the class index is derived as Eq. (18):

$$classIdx = sum ≫ ( sample bit depth - 4 ) \qquad Eq . ( 18 )$$

The value of classIdx is in the range of 0 to 24, same as in ECM-8.0. The classifier usage is signaled for each luma filter set in APS.

Both the band-based and the residual-based classifiers classify the value among the whole dynamic range uniformly. However, the sample value or the residual value may not have an ideal uniform distribution among the dynamic range, this uniform classification may lead to coarse classification results and may not be coding efficiency.

Some aspects of the disclosure provide techniques for non-uniform classification for ALF classifier. The non-uniform classification can lead to better coding efficiency in some examples. In some examples, non-uniform classification represents that the number of classes for different value intervals may be different instead of using the same number of classes for all value intervals and classifying the whole dynamic range uniformly. For example, encoder/decoder can calculate a classification value associated with a classification unit for applying the filter on the classification unit, the classification unit is in a current block. The encoder/decoder can determine a filtering class from a plurality of filtering classes for the classification unit based on the classification value in a dynamic range, the plurality of filtering classes is distributed in the dynamic range according to a non-uniform distribution. Further, the encoder/decoder can obtain filter coefficients associated with the filtering class, generate at least a filtered sample of classification unit according to the filter coefficients, and reconstruct the current block based on at least the filtered sample.

For example, the dynamic range N is divided into k sub-intervals, the index of each sub-interval ranges from 0 to k-1, and let the value range (size) of each sub-interval is set to [To, r₁, . . . , rₖ₋₁], respectively. Each sub-interval has its corresponding class number [num₀, num₁, . . . , numₖ₋₁], and the sum of class numbers for all sub-intervals is equal to the total class number used for ALF classifier numₜₒₜₐₗ. The classification is performed based on which sub-interval the value that needs to be classified belongs to and the corresponding number of classes of the sub-interval.

In some examples, the dynamic range N is divided into k sub-intervals, where each sub-interval is associated with each own class and wherein this sub-intervals division is performed in a no-uniform way according to specified r₀, r₁, . . . , rₖ₋₁. In other words, value k in this embodiment represents the total number of classes (all num₀, num₁, . . . , numₖ₋₁ are equal to 1) and the classification is performed by checking to which subinterval the subject value belongs to.

In an example, the class number for a given value v is determined by Eq. (19)

$$classIdx = arg {min}_{k} \vert v - {\sum }_{i = 0}^{k} {r}_{i} \vert \qquad Eq . ( 19 )$$

where argmin returns the index of the smallest elements.

In some examples, the dynamic range N is divided into k sub-intervals, where each sub-interval is associated with each own class and wherein this sub-intervals division is performed in a no-uniform way according to specified r₀, r₁, . . . , rₖ₋₁. These k sub-intervals have their corresponding numbers of classes num₀, num₁, . . . , numₖ₋₁. The value range rᵢ and the number of classes numᵢ for each sub-interval should satisfy that

$$\frac{{r}_{0}}{n u {m}_{0}} , \frac{{r}_{1}}{n u {m}_{1}} , … , \frac{{r}_{k - 1}}{n u {m}_{k - 1}}$$

are not all the same.

In an example, all sub-intervals use the same number of classes, which should be

$$\frac{n u {m}_{t o t a l}}{k} .$$

It should be noted that in this embodiment, some of the numbers of classes num₀, num₁, . . . , numₖ₋₁ can be equal to 0.

In some examples, the dynamic range N is uniformly divided into k sub-intervals, the value range of each sub-interval is N/k. But all the sub-intervals use different class number, i.e. all num₀, num₁, . . . , numₖ₋₁ cannot be the same. To perform the non-uniform classification, a sub-interval index is first derived for the value to be classified (v), then the final class index is generated based on the number of classes of the sub-interval as following. 1) Generate the sub-interval index of the value by

$$i d x = \frac{v * k}{N} ;$$

2) Classify the value based on the corresponding class number as Eq. (20):

$$lassIdx = \{ \begin{matrix}value * \frac{{num}_{0}}{{r}_{0}} , if idx = 0 \\ ( value mod ( {r}_{0} + … + {r}_{idx - 1} ) ) * \frac{{num}_{idx}}{{r}_{idx}} + {num}_{0} + … + {num}_{idx - 1} , else\end{matrix} \qquad Eq . ( 20 )$$

According to an aspect of the disclosure, the non-uniform classification can be signaled by related syntaxes in HLS (VPS, SPS, PPS, APS, picture header, slice header).

In some examples, the sub-interval number, value range of each sub-interval, class number of each sub-interval and other related parameters use pre-defined parameters in both encoder and decoder. A flag is signaled to indicate whether the non-uniform classification is used. If the flag is parsed to be true at decoder, the corresponding non-uniform classification would be applied based on the pre-defined parameters.

In some examples, a flag is signaled to indicate whether the non-uniform classification is used. If this flag is true, the remaining non-uniform classification related syntaxes would be further signaled to the decoder side. The non-uniform classification is applied at decoder based on the parsed parameters.

According to another aspect of the disclosure, the non-uniform classification can be used by any classifier that directly uses the value to classify. In some examples, the value used to be classified is derived from the sample value.

In some examples, the value used to be classified is derived from the residual value.

In some examples, the value used to be classified is derived from a N×N window that covers the M×M target unit, where N≥M.

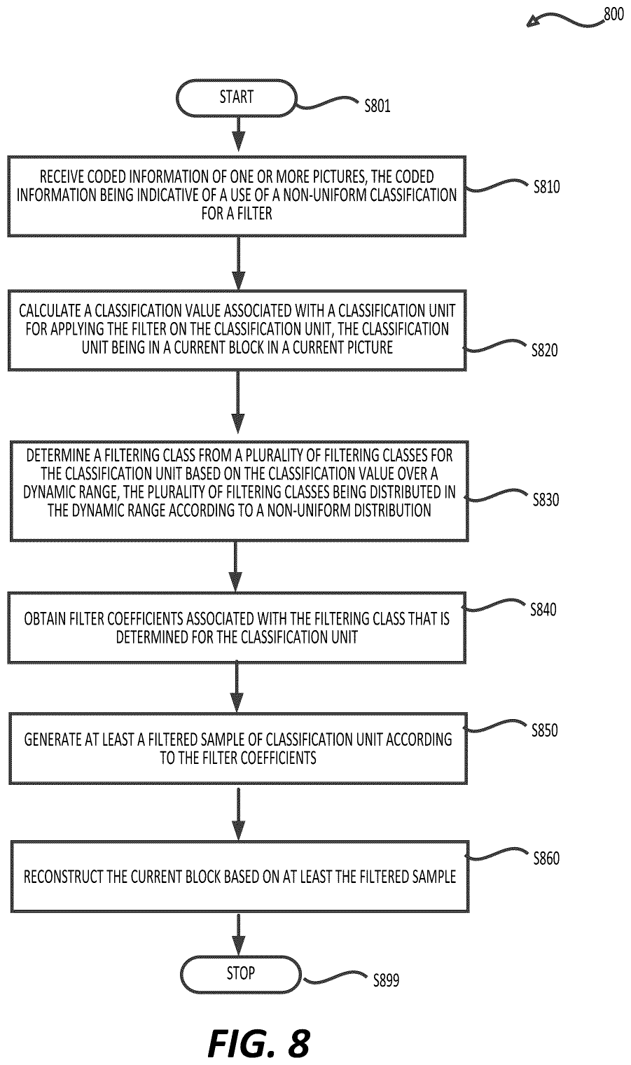

FIG. 8 shows a flow chart outlining a process (800) according to an embodiment of the disclosure. The process (800) can be used in a video decoder. In various embodiments, the process (800) is executed by processing circuitry, such as the processing circuitry that performs functions of the video decoder (110), the processing circuitry that performs functions of the video decoder (210), and the like. In some embodiments, the process (800) is implemented in software instructions, thus when the processing circuitry executes the software instructions, the processing circuitry performs the process (800). The process starts at (S801) and proceeds to (S810).

At (S810), coded information of one or more pictures is received. The coded information is indicative of a use of a non-uniform classification for a filter.

At (S820), a classification value associated with a classification unit for applying the filter on the classification unit is calculated, the classification unit is in a current block in a current picture.

At (S830), a filtering class is determined from a plurality of filtering classes for the classification unit based on the classification value in a dynamic range, the plurality of filtering classes are distributed in the dynamic range according to a non-uniform distribution.

At (S840), filter coefficients associated with the filtering class are determined.

At (S850), at least a filtered sample of classification unit is generated according to the filter coefficients.

At (S860), the current block is reconstructed based on at least the filtered sample.

In some examples, the dynamic range includes at least a first filtering class associated with a first range of values in the dynamic range and a second filtering class associated with a second range of values in the dynamic range, the first range of values has a difference range size from the second range of values.

In some examples, the dynamic range includes sub-intervals with indices ranging from 0 to k-1, k is a sub-interval number, range sizes of the sub-intervals are set to [r₀, r₁, . . . rₖ₋₁] respectively, the sub-intervals have corresponding class numbers [num₀, num₁, . . . , numₖ₋₁], and a sum of the corresponding class numbers for the sub-intervals is equal to a total class number numₜₒₜₐₗ of the plurality of filtering classes. Then, in some examples, the filtering class is determined based on a specific sub-interval that the classification value belongs to and a specific class number in the specific sub-interval.

In some examples, the dynamic range is non-uniformly divided into the sub-intervals, each sub-interval is associated with a corresponding filtering class in the plurality of filtering classes. Then, the filtering class is determined based on the specific sub-interval the classification value belongs.

In some examples, the dynamic range includes the sub-intervals with respective non-uniform interval sizes r₀, r₁, . . . , rₖ₋₁, and

$$\frac{{r}_{0}}{n u {m}_{0}} , \frac{{r}_{1}}{n u {m}_{1}} , … , \frac{{r}_{k - 1}}{n u {m}_{k - 1}}$$

are not of a same value. In an example, num₀, num₁, . . . , numₖ₋₁ are of a same value.

In some examples, the dynamic range includes at least a first sub-interval and a second sub-interval of different interval ranges, the first sub-interval and the second sub-interval has a same class number.

In some examples, the dynamic range includes at least a first sub-interval and a second sub-interval of a same interval size, the first sub-interval has a first class number, the second sub-interval has a second class number, and the first class number and the second class number are different.

In some examples, the dynamic range includes the sub-intervals of a same interval size, the corresponding class numbers num₀, num₁, . . . , numₖ₋₁ of the sub-intervals are not of a same number.

In some examples, a sub-interval that the classification value belongs to is determined and a specific class in the sub-interval for the classification value is determined.

In some examples, from one or more high level syntax elements in the coded information, one or more signals for the non-uniform distribution are decoded, the one or more high level syntax elements includes one of a video parameter set (VPS), a sequence parameter set (SPS), a picture parameter set (PPS), an adaptation parameter set (APS), a picture header, a slice header.

In an example, the sub-interval number, range sizes of the sub-intervals, and class numbers in the sub-intervals are predefined parameters for the non-uniform distribution. A flag that indicates whether the non-uniform distribution is used is decoded.

In another example, a flag that indicates whether the non-uniform distribution is used is decoded. When the flag indicates that the non-uniform distribution is used, at least one of the sub-interval number, range sizes of the sub-intervals, and class numbers in the sub-intervals is decoded from the coded information.

It is noted that the filter can be any suitable filter that is based on a classifier. In some examples, the filter is an adaptive loop filter.

In some examples, the classification value is one of a sample value, a residual value, and a derived value from a window that covers the classification unit.

It is noted that the classification unit can be any suitable size. In an example, the classification unit is 2×2 block. In another example, the classification unit is 4×4 block.

Then, the process proceeds to (S899) and terminates.

The process (800) can be suitably adapted. Step(s) in the process (800) can be modified and/or omitted. Additional step(s) can be added. Any suitable order of implementation can be used.

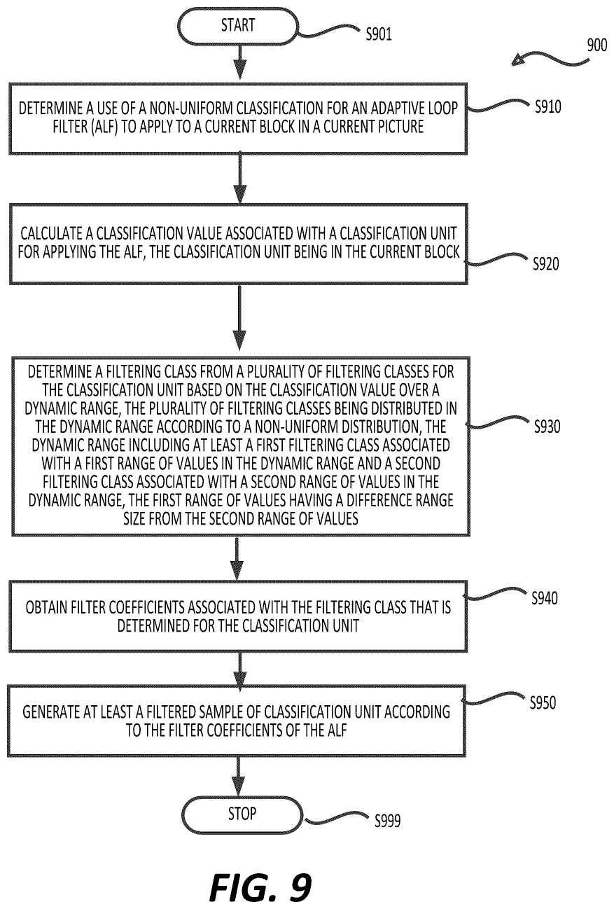

FIG. 9 shows a flow chart outlining a process (900) according to an embodiment of the disclosure. The process (900) can be used in a video encoder. In various embodiments, the process (900) is executed by processing circuitry, such as the processing circuitry that performs functions of the video encoder (103), the processing circuitry that performs functions of the video encoder (303), and the like. In some embodiments, the process (900) is implemented in software instructions, thus when the processing circuitry executes the software instructions, the processing circuitry performs the process (900). The process starts at (S901) and proceeds to (S910).

At (S910), a use of a non-uniform classification for an adaptive loop filter (ALF) to apply to a current block in a current picture is determined.

At (S920), a classification value associated with a classification unit for applying the ALF is determined, the classification unit is associated with the current block.

At (S930), a filtering class is selected from a plurality of filtering classes for the classification unit based on the classification value in a dynamic range, the plurality of filtering classes is distributed in the dynamic range according to a non-uniform distribution, the dynamic range includes at least a first filtering class with a first range of values in the dynamic range and a second filtering class with a second range of values in the dynamic range, the first range of values has a difference range size from the second range of values.

At (S940), filter coefficients associated with the filtering class are obtained.

At (S950), at least a filtered sample of classification unit is generated according to the filter coefficients of the ALF.

In some examples, the dynamic range includes sub-intervals with indices ranging from 0 to k-1, k is a sub-interval number for the sub-intervals, range sizes of the sub-intervals are set to [r₀, r₁, . . . , rₖ₋₁] respectively, the sub-intervals have corresponding class numbers [num₀, num₁, . . . , numₖ₋₁], and a sum of the corresponding class numbers for the sub-intervals is equal to a total class number numₜₒₜₐₗ of the plurality of filtering classes. In some examples, a specific sub-interval that the classification value belongs is determined and and a specific class number in the specific sub-interval is determined.

In some examples, the dynamic range includes the sub-intervals with respective non-uniform interval sizes r₀, r₁, . . . , rₖ₋₁, and num₀, num₁, . . . , numₖ₋₁ are of a same value.

In some examples, the dynamic range includes the sub-intervals of a same interval size, the corresponding class numbers num₀, num₁, . . . , numₖ₋₁ of the sub-intervals are not of a same number.

Then, the process proceeds to (S999) and terminates.

The process (900) can be suitably adapted. Step(s) in the process (900) can be modified and/or omitted. Additional step(s) can be added. Any suitable order of implementation can be used.

According to an aspect of the disclosure, a method of processing visual media data is provided. In the method, a bitstream of visual media data is processed according to a format rule. For example, the bitstream may be a bitstream that is decoded/encoded in any of the decoding and/or encoding methods described herein. The format rule may specify one or more constraints of the bitstream and/or one or more processes to be performed by the decoder and/or encoder.

In an example, the bitstream includes coded information of one or more pictures including a current picture. The format rule specifies that a use of a non-uniform classification for an adaptive loop filter (ALF) is determined for applying onto a current block in the current picture, a classification value associated with a classification unit for applying the ALF is determined, the classification unit being in the current block, a filtering class is determined from a plurality of filtering classes for the classification unit based on the classification value in a dynamic range, the plurality of filtering classes being distributed in the dynamic range according to a non-uniform distribution, the dynamic range including at least a first filtering class corresponding to a first range of values in the dynamic range and a second filtering class corresponding to a second range of values in the dynamic range, the first range of values having a difference range size from the second range of values, filter coefficients associated with the filtering class are determined, and at least a filtered sample of classification unit is generated according to the filter coefficients of the ALF.

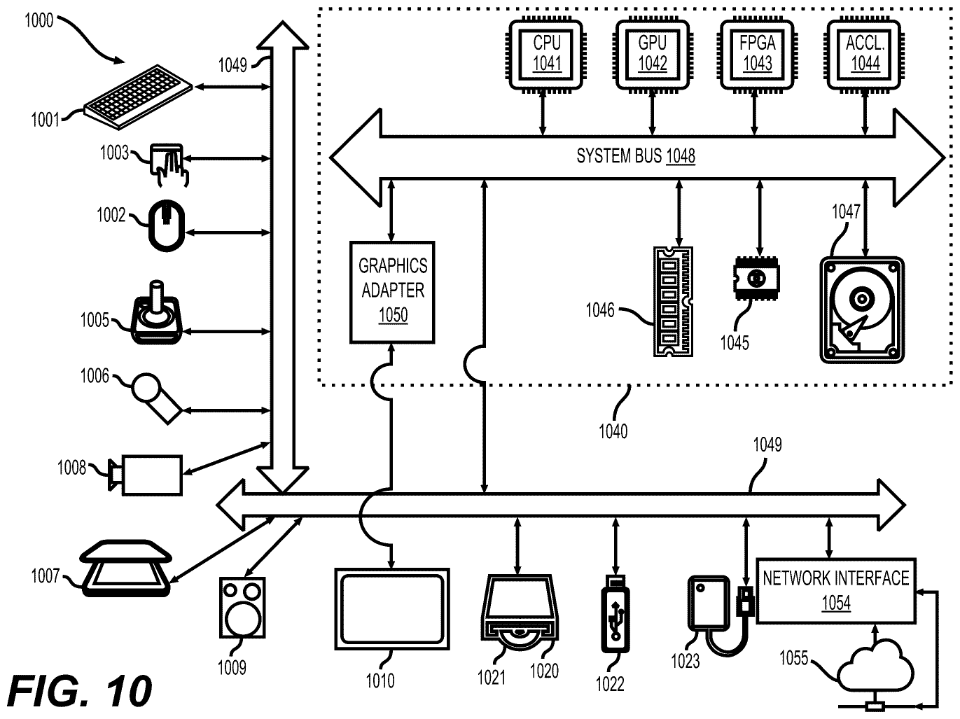

The techniques described above, can be implemented as computer software using computer-readable instructions and physically stored in one or more computer-readable media. For example, FIG. 10 shows a computer system (1000) suitable for implementing certain embodiments of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 10 for computer system (1000) are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system (1000).

Computer system (1000) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (1001), mouse (1002), trackpad (1003), touch screen (1010), data-glove (not shown), joystick (1005), microphone (1006), scanner (1007), camera (1008).

Computer system (1000) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (1010), data-glove (not shown), or joystick (1005), but there can also be tactile feedback devices that do not serve as input devices), audio output devices (such as: speakers (1009), headphones (not depicted)), visual output devices (such as screens (1010) to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system (1000) can also include human accessible storage devices and their associated media such as optical media including CD/DVD ROM/RW (1020) with CD/DVD or the like media (1021), thumb-drive (1022), removable hard drive or solid state drive (1023), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (1000) can also include an interface (1054) to one or more communication networks (1055). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (1049) (such as, for example USB ports of the computer system (1000)); others are commonly integrated into the core of the computer system (1000) by attachment to a system bus as described below (for example Ethernet interface into a PC computer system or cellular network interface into a smartphone computer system). Using any of these networks, computer system (1000) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (1040) of the computer system (1000).

The core (1040) can include one or more Central Processing Units (CPU) (1041), Graphics Processing Units (GPU) (1042), specialized programmable processing units in the form of Field Programmable Gate Areas (FPGA) (1043), hardware accelerators for certain tasks (1044), graphics adapters (1050), and so forth. These devices, along with Read-only memory (ROM) (1045), Random-access memory (1046), internal mass storage such as internal non-user accessible hard drives, SSDs, and the like (1047), may be connected through a system bus (1048). In some computer systems, the system bus (1048) can be accessible in the form of one or more physical plugs to enable extensions by additional CPUs, GPU, and the like. The peripheral devices can be attached either directly to the core's system bus (1048), or through a peripheral bus (1049). In an example, the screen (1010) can be connected to the graphics adapter (1050). Architectures for a peripheral bus include PCI, USB, and the like.

CPUs (1041), GPUs (1042), FPGAs (1043), and accelerators (1044) can execute certain instructions that, in combination, can make up the aforementioned computer code. That computer code can be stored in ROM (1045) or RAM (1046). Transitional data can also be stored in RAM (1046), whereas permanent data can be stored for example, in the internal mass storage (1047). Fast storage and retrieve to any of the memory devices can be enabled through the use of cache memory, that can be closely associated with one or more CPU (1041), GPU (1042), mass storage (1047), ROM (1045), RAM (1046), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (1000), and specifically the core (1040) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (1040) that are of non-transitory nature, such as core-internal mass storage (1047) or ROM (1045). The software implementing various embodiments of the present disclosure can be stored in such devices and executed by core (1040). A computer-readable medium can include one or more memory devices or chips, according to particular needs. The software can cause the core (1040) and specifically the processors therein (including CPU, GPU, FPGA, and the like) to execute particular processes or particular parts of particular processes described herein, including defining data structures stored in RAM (1046) and modifying such data structures according to the processes defined by the software. In addition or as an alternative, the computer system can provide functionality as a result of logic hardwired or otherwise embodied in a circuit (for example: accelerator (1044)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. A method for video decoding, comprising:
receiving coded information of one or more pictures, the coded information being indicative of a use of a non-uniform classification for a filter;
calculating a classification value associated with a classification unit for applying the filter on the classification unit, the classification unit being in a current block in a current picture;
determining a filtering class from a plurality of filtering classes for the classification unit based on the classification value in a dynamic range, the plurality of filtering classes being distributed in the dynamic range according to a non-uniform distribution;
obtaining filter coefficients associated with the filtering class that is determined for the classification unit;
generating at least a filtered sample of classification unit according to the filter coefficients; and
reconstructing the current block based on at least the filtered sample.

2. The method of claim 1, wherein the dynamic range includes at least a first filtering class corresponding to a first range of values in the dynamic range and a second filtering class corresponding to a second range of values in the dynamic range, the first range of values has a difference range size from the second range of values.

3. The method of claim 1, wherein the dynamic range includes sub-intervals with indices ranging from 0 to k-1, k is a sub-interval number, range sizes of the sub-intervals are set to [r₀, r₁, . . . , rₖ₋₁] respectively, the sub-intervals have corresponding class numbers [num₀, num₁, . . . , numₖ₋₁], and a sum of the corresponding class numbers for the sub-intervals is equal to a total class number numₜₒₜₐₗ of the plurality of filtering classes, and the determining the filter class comprises:
determining the filtering class based on a specific sub-interval that the classification value belongs to and a specific class number in the specific sub-interval.

4. The method of claim 3, wherein the dynamic range is non-uniformly divided into the sub-intervals, each sub-interval is associated with one filtering class in the plurality of filtering classes, and the determining the filter class comprises:
determining the filtering class based on the specific sub-interval the classification value belongs.

5. The method of claim 3, wherein the dynamic range includes the sub-intervals with non-uniform interval sizes r₀, r₁, . . . , rₖ₋₁, and
$$\frac{{r}_{0}}{n u {m}_{0}} , \frac{{r}_{1}}{n u {m}_{1}} , … , \frac{{r}_{k - 1}}{n u {m}_{k - 1}}$$
are not or a same value.

6. The method of claim 5, wherein num₀, num₁, . . . , numₖ₋₁ are of a same value.

7. The method of claim 3, wherein the dynamic range includes at least a first sub-interval and a second sub-interval of different interval ranges, the first sub-interval and the second sub-interval has a same class number.

8. The method of claim 3, wherein the dynamic range includes at least a first sub-interval and a second sub-interval of a same interval size, the first sub-interval has a first class number, the second sub-interval has a second class number, and the first class number is different from the second class number.

9. The method of claim 3, wherein the dynamic range includes the sub-intervals of a same interval size, the corresponding class numbers num₀, num₁, . . . , numₖ₋₁ of the sub-intervals are not of a same number.

10. The method of claim 9, further comprising:
determining a specific sub-interval that the classification value belongs to; and
determining a specific class in the specific sub-interval for the classification value.

11. The method of claim 3, further comprising:
decoding, from one or more high level syntax elements in the coded information, one or more signals for the non-uniform distribution, the one or more high level syntax elements being in a video parameter set (VPS), a sequence parameter set (SPS), a picture parameter set (PPS), an adaptation parameter set (APS), a picture header, a slice header.

12. The method of claim 11, wherein the sub-interval number, range sizes of the sub-intervals, and class numbers in the sub-intervals are predefined parameters for the non-uniform distribution, and the method further comprises:
decoding, from the coded information, a flag that indicates whether the non-uniform distribution is used.

13. The method of claim 11, further comprising:
decoding, from the coded information, a flag that indicates whether the non-uniform distribution is used; and
decoding, when the flag indicates that the non-uniform distribution is used, at least one the sub-interval number, range sizes of the sub-intervals, and class numbers in the sub-intervals from the coded information.

14. The method of claim 1, wherein the filter is an adaptive loop filter.

15. The method of claim 1, wherein the classification value is one of a sample value, a residual value, and a derived value from a window that covers the classification unit.

16. A method for video encoding, comprising:
determining a use of a non-uniform classification for an adaptive loop filter (ALF) to apply to a current block in a current picture;
calculating a classification value associated with a classification unit for applying the ALF, the classification unit being in the current block;
determining a filtering class from a plurality of filtering classes for the classification unit based on the classification value in a dynamic range, the plurality of filtering classes being distributed in the dynamic range according to a non-uniform distribution;
obtaining filter coefficients associated with the filtering class that is determined for the classification unit;
generating at least a filtered sample of classification unit according to the filter coefficients; and
encoding the current block based on at least the filtered sample.

17. The method of claim 16, wherein the dynamic range includes at least a first filtering class corresponding to a first range of values in the dynamic range and a second filtering class corresponding to a second range of values in the dynamic range, the first range of values has a difference range size from the second range of values.

18. The method of claim 16, wherein the dynamic range includes sub-intervals with indices ranging from 0 to k-1, k is a sub-interval number, range sizes of the sub-intervals are set to [r₀, r₁, . . . , rₖ₋₁] respectively, the sub-intervals have corresponding class numbers [num₀, num₁, . . . , numₖ₋₁], and a sum of the corresponding class numbers for the sub-intervals is equal to a total class number numₜₒₜₐₗ of the plurality of filtering classes, and the determining the filtering class comprises:
determine the filtering class based on a specific sub-interval that the classification value belongs to and a specific class number in the specific sub-interval.

19. The method of claim 18, wherein the dynamic range is non-uniformly divided into the sub-intervals, each sub-interval is associated with one filtering class in the plurality of filtering classes, and the determining the filtering class comprises:
determining the filtering class based on the specific sub-interval the classification value belongs.

20. A non-transitory computer readable medium storing a video media bitstream that is encoded by an encoding method, the encoding method comprising:
determining a use of a non-uniform classification for an adaptive loop filter (ALF) to apply to a current block in a current picture;
calculating a classification value associated with a classification unit for applying the ALF, the classification unit being in the current block;
determining a filtering class from a plurality of filtering classes for the classification unit based on the classification value in a dynamic range, the plurality of filtering classes being distributed in the dynamic range according to a non-uniform distribution;
obtaining filter coefficients associated with the filtering class that is determined for the classification unit;
generating at least a filtered sample of classification unit according to the filter coefficients; and
encoding the current block into encoded information in the video media bitstream based on at least the filtered sample.
